(19) United States
(12) Patent Application Publication
(10) Pub. No.: US 2018/0218347 A1
(43) Pub. Date: Aug. 2, 2018

(54) TRANSACTION SIGNALING DEVICES IN SHOPPING ENVIRONMENT

(71) Applicant: Wal-Mart Stores, Inc., Bentonville, AR (US)

(72) Inventors: Jimmie R. CLARK, Fayetteville, AR (US); Subodh Kumar PANDEY, Bentonville, AR (US); Christopher Soames JOHNSON, Pea Ridge, AR (US); Ricky L. LEWIS, Rogers, AR (US); Richard Andrew WHITE, Pineville, MO (US)

(21) Appl. No.: 15/746,946

(22) PCT Filed: Aug. 17, 2016
(86) PCT No.: PCT/US16/47295

§ 371 Date: Jan. 23, 2018

Related U.S. Application Data
(60) Provisional application No. 62/206,374, filed on Aug. 18, 2015.

(51) Int. Cl. G06Q 20/20; G06Q 20/32; G08B 5/36; G08B 21/18; B62B 5/00

(52) U.S. Cl. CPC G06Q 20/202; G06Q 20/322; B62B 5/0096; G08B 21/18; G08B 5/36

(57) ABSTRACT

Provided are a system and method for notification. A communication is established between a mobile application at a user mobile electronic device and a shopping cart. The status indicator on the shopping cart is activated having a first state indicating that the shopping cart is in use. After a checkout process is completed, the status indicator is changed to have a second state indicating the completion of the checkout process.

### CROSS-REFERENCE TO RELATED APPLICATION

This application claims priority to U.S. Provisional Application No. 62/206,374 having a filing date of Aug. 18, 2015 the entire contents of which are hereby incorporated by reference.

### FIELD

The present concepts relate generally to shopping environments that include electronic systems, and more specifically, to checkout notification signaling mechanisms and methods.

### BACKGROUND

Store customers often encounter situations after shopping at a store where an alarm is activated due to a scanner at the exit that detects the shopper leaving the store with items that are erroneously determined to not have been purchased.

### BRIEF SUMMARY

In one aspect, provided is a method for notification of a store checkout, comprising: establishing a communication between a mobile application at a user mobile electronic device and a shopping cart; activating a status indicator on the shopping cart to have a first state indicating that the shopping cart is in use; completing a checkout process; and changing the status indicator to have a second state indicating the completion of the checkout process.

In some embodiments, the status indicator is a light emitting device that emits light having a first color in the first state and emits light having a second color light in the second state.

In some embodiments, the checkout process includes payment of all of the items in the shopping cart.

In some embodiments, the communication is established by the shopping cart providing the user mobile electronic device with an identifier.

In some embodiments, the identifier of the shopping cart is used by a store server to activate the status indicator on the shopping cart.

In some embodiments, the checkout process is performed by the mobile application of the user mobile electronic device, which in response sends a signal to the store server to change the status indicator from the first state to the second state.

In some embodiments, the checkout process is performed by a combination of a point of sale system and the mobile application of the user mobile electronic device.

In some embodiments, the identifier includes a serial number of the shopping cart.

In another aspect, provided is a system for notification of a store checkout, comprising: a shopping cart, including: a processor that establishes a communication between a mobile application at a user mobile electronic device; and a status indicator that indicates at least one of a first state where the mobile application is in communication with the shopping cart or a second state where the store checkout is complete. The system further comprises a store server that receives a signal from the mobile application and at least one of activates the status indicator on the shopping cart when the signal includes an identifier of the shopping cart confirming communication between the mobile application and the shopping cart or changes the status indicator from the first state to the second state when the signal includes a checkout completion acknowledgement indicating the completion of the store checkout.

In some embodiments, the system comprises a point of sale (POS) device at a checkout region of the store that processes data related to the store checkout.

In some embodiments, the status indicator is a light emitting device that emits light having a first color in the first state and emits light having a second color light in the second state.

In some embodiments, the checkout process includes payment of all of the items in the shopping cart.

In some embodiments, the shopping cart processor outputs to the user mobile electronic device an identifier.

In some embodiments, the store server activate the status indicator to be in the first state on the shopping cart in response to receiving the identifier from the mobile electronic device.

In some embodiments, the store server changes the status indicator from the first state to the second state in response to the store server receiving the checkout completion acknowledgement from the mobile electronic device.

In some embodiments, the store server changes the status indicator from the first state to the second state in response to the store server receiving the checkout completion acknowledgement from a point of sale system.

In some embodiments, the identifier includes a serial number of the shopping cart.

In another aspect, provided is a method for changing a status of an indicator on a store shopping cart, comprising: activating a status indicator on the shopping cart to have a first state indicating that a shopping cart is in use when a communication is established between the shopping cart and a mobile electronic device of a shopping using the shopping cart; and changing the status indicator to have a second state indicating the completion of the checkout process when the user has purchased items of interest.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a network diagram illustrating a shopping environment, in accordance with some embodiments.

FIG. 2 is a diagram illustrating data exchanges between a mobile electronic device of a shopper, a shopping cart processor, and a store server, in accordance with some embodiments.

FIG. 3 is a workflow diagram illustrating relationships between entities in a shopping environment, in accordance with some embodiments.

### DETAILED DESCRIPTION

In the following description, specific details are set forth although it should be appreciated by one of ordinary skill in the art that the systems and methods can be practiced without at least some of the details. In some instances, known features or processes are not described in detail so as to not obscure the present invention.

In brief overview, a shopping cart configured with an electronic device is paired with a mobile electronic device of the user using the shopping cart, for example, prior to the user shopping for items in the store. The shopping cart includes a status indicator that is illuminated or otherwise indicates a state that the mobile electronic device and shopping cart are paired, for example, illuminating a predetermined color such as red, yellow, or other visual or audio indicator of preference. The user at the store may add store items to the shopping cart, and may use the mobile electronic device to identify store items for purchase. Other purchase-related functions may be performed by one or more applications stored at and executed by the mobile electronic device. After the user completes shopping for store items, the user can complete a checkout process from the user's mobile electronic device and/or conventional checkout such as a point of sale (POS) system. An observer such as a store clerk, security personnel, or manager, can determine whether the user has completed the checkout process, in particular, paid for the items, by the status indicator, for example, viewing the color of the status indicator on the shopping cart. For example, the status indicator can indicate a state that the checkout process has been completed by illuminating a predetermined color such as green.

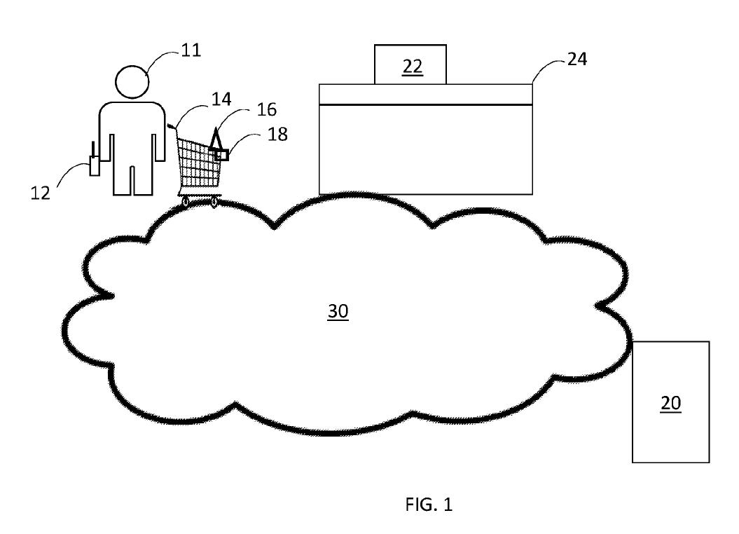

FIG. 1 is a network diagram illustrating shopping environment, in accordance with some embodiments. The shopping environment includes a shopper 11 with a mobile electronic device 12. The shopper 11 is in possession of a shopping cart 14 or the like in which items for purchase may be placed. The mobile electronic device 12 can be a smartphone, electronic notebook computer, or other electronic device having at a least a processor, memory, and user interface, and can store and execute code that may perform checkout functions and/or other functions of embodiments of the present inventive concepts. The mobile electronic device 12 may include a card reader, barcode scanner, or the like that receives electronic data related to a checkout process and for establishing communication with the shopping cart 14. Electronic communications using Bluetooth™, WiFI, radio frequency identification (RFID), and so on may be used by the various electronic elements of the shopping environment.

A processor 18 and status indicator 16 are located at the shopping cart 14. The status indicator 16 can include one or more LED lights or other visual, audio, or other sensory device that generate indicator signals that may change states. The status indicator 16 may comprise a buzzer, bell, siren, speaker or other sound generating device, and/or a lamp that may light or flash. For example, in embodiments where the status indicator 16 includes an LED light, the LED light can illuminate a red color in a first state, and a green color in a second state. In some embodiments, multiple LEDs are positioned on the shopping cart 14 that can be viewed by the observer when illuminated. For example, one LED may be a red-emitting LED, which is activated when the shopper's mobile electronic device 12 is paired with the shopping cart 14, and another LED may be a green-emitting LED, which is activated when the checkout process is complete. In other embodiments, the status indicator 16 can include a single light-emitting device that can generate wavelengths in the visible spectrum, thereby emitting different colors, depending on a state, for example, red or green. The state of the LED light indicator 16 may depend on whether the shopper 11 is authorized to exit the store at checkout 24. The processor 18 outputs signals to the status indicator 16 for controlling a state of the status indicator 16, for example, establishing when the LED light illuminates a red color or a green color. In some embodiments, a different light emitting device is activated for notification of a checkout completion than for an activation of the shopping cart 14.

The user's device 12 may be configured with a software application stored in memory and executed by a processor for exchanging data with the processor 18 on the shopping cart 14.

The shopping environment may also include a POS system 22 or related computer system at the store checkout 24. The POS system 22, along with the user mobile electronic device 12, shopping cart processor 18, and a store server 20 can communicate with each other and/or other electronic devices via a network 30, which may include a local area network (LAN), WiFi network, wide area network (WAN), and/or other communication network. The POS system 22 or application executed at the mobile device 12 can perform a checkout process. In some embodiments, both the mobile device 12 and the POS system 22 may be part of a checkout process. For example, the mobile device application may store a list of items added to the shopping cart 14, and the POS system 22 can perform final payment processing when the shopper 11 desires to use a different payment method than that stored on the mobile device 12, or when there are issues with the mobile device application checkout process.

In some embodiments, the mobile electronic device 12 stores and executes an application that performs checkout functions. Financial information such as credit card number and so on can be pre-stored as part of a customer profile. In these embodiments, the shopper 11 is not required to proceed to the checkout counter 24 to purchase items in the shopping cart 14 since the checkout is performed at the mobile electronic device 12.

The store server 20 can receive a signal from the user mobile electronic device 12 and activate the status indicator 16 on the shopping cart 14 when the signal includes an identifier of the shopping cart 14 confirming a pairing, or communication exchange, between the mobile device 12 and the shopping cart 14. The store server can also receive a checkout completion acknowledgement system from the mobile electronic device 12 or the POS system 22, and in response can change the status indicator 16 to a different state, for example, a different color, or illuminating a different light on the shopping cart 14.

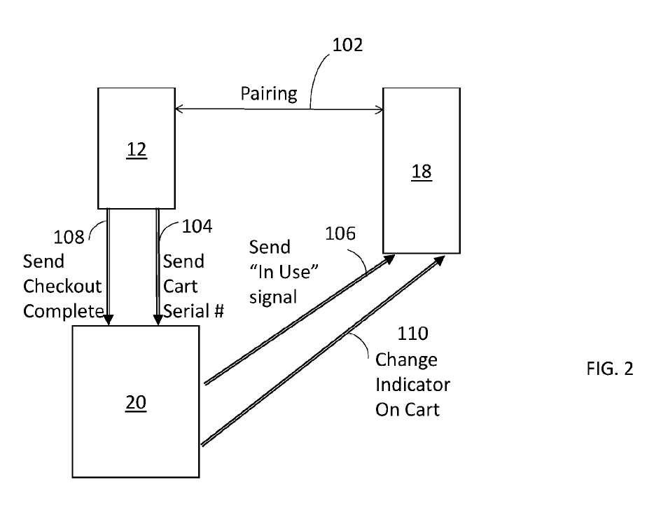

FIG. 2 is a diagram illustrating data exchanges between a mobile electronic device 12 of a shopper 11, a shopping cart processor 18, and a store server 20, in accordance with some embodiments. In describing the method 200 reference is made to elements of the shopping environment of FIG. 1.

The mobile electronic device 12 is paired (102) with the shopping cart processor 18. When the shopper 11 enters the store with the mobile electronic device 12, the mobile electronic device 12 can be authenticated or otherwise permitted to use the store's WiFi network or the like. The shopper 11 can select a shopping cart 14. The shopper 11 can use the mobile electronic device 12 to scan a barcode or other identifier on the shopping cart 14. In some embodiments, tags or other identification elements may be used, and RFID data may be exchanged.

At step 104, the mobile electronic device 12 outputs the serial number of the shopping cart 14 retrieved in step 102 to the store server 20. The mobile electronic device 12 can output the serial number, and/or other data, to the store server 20 via the store's WiFi network. At step 106, the store server 20 uses the shopping cart identifier, e.g., serial number, to generate and output a signal to the cart processor 18, which changes the status indicator 16 to indicate that the shopping cart 14 is in use. For example, the status indicator 16 can generate a color light indicating that the cart 14 is in use, for example, a red light.

After the shopper 11 selects items at the store for purchase which are placed in the shopping cart 14 or carried by the shopper 11, the shopper 11 may proceed with the shopping cart 14 to the checkout counter 24 where the shopper 11 may purchase the items in the shopping cart 14 and completes the checkout process. The store server 20 may receive a checkout completion acknowledgement (108) along with item purchase information, for example, from the mobile electronic device 12 in embodiments where the mobile electronic device 12 stores and executes an application that performs checkout functions. In other embodiments, the store server 20 receives a checkout completion acknowledgement from the POS system 22.

The store server 20, after receiving the checkout completion acknowledgement from the POS system 22 or the mobile electronic device outputs a signal to the cart processor 18 to change the status indicator 16, for example, to emit a green light, or providing another audible, visual or other alarm device indicating that the checkout is complete with respect to the shopping cart 14.

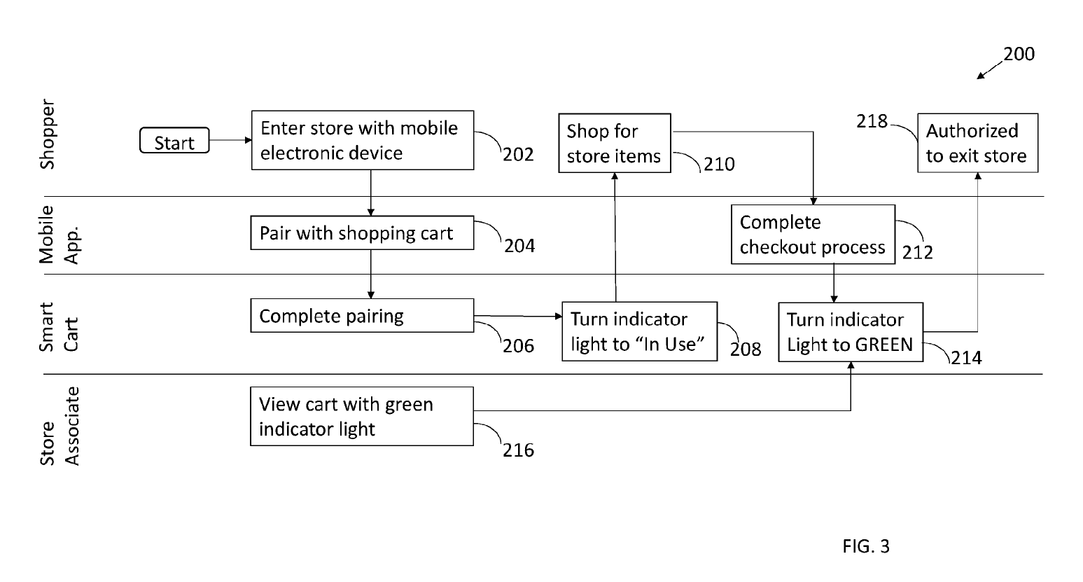

FIG. 3 is a workflow diagram illustrating relationships between entities in a shopping environment, in accordance with some embodiments. In describing a notification signaling method 200, reference is made to the entities of the shopping environment of FIG. 1, which may include but not be limited to shopper 11, mobile electronic device 12, and shopping cart 14 (also referred to as a smart cart or smart shopping cart). Also described in FIG. 3 but not shown in FIG. 1 is a store associate who may monitor shoppers exiting a store with a shopping cart and determining whether the shoppers have completed a checkout, e.g., purchased items in the shopping carts.

At block 202, the shopper 11 enters a store. The shopper has a mobile electronic device 12 configured to include an application that is stored in memory and executed by a processor of the mobile electronic device 12. As described above, the mobile device application includes functionality that establishes pairing with a shopping cart 14. Also, the application receives data from a barcode scanner or other input device on the mobile electronic device 12 for scanning store items, adding item data, checking prices, collecting item data, and so on.

At block 204, the mobile device application performs an operation that pairs the mobile electronic device 12 with the shopping cart 14, referred to in method 200 as a smart cart. A pairing operation can be the same as or similar to the pairing operation described in FIG. 2. Therefore, details on the pairing operation are not repeated due to brevity.

At block 206, the pairing is complete after the mobile electronic device 12 receives the shopping cart identifier, such as the cart serial number.

At block 208, the status indicator 16 emits a color indicating that the shopping cart 14 is in use, for example, activates a red-emitting LED or the like.

At block 210, the store customer 11 shops for store items. Here, the customer 11 can place items of interest in the shopping cart 14. The mobile device application may be used to identify and confirm the acquisition by the customer of the items. RFID or the like may be used to scan an item, or more specifically, a tag or other identifier on the item, to confirm that the item has been selected. After the customer 11 completes shopping, the customer 11 may proceed to the checkout counter 24 and/or complete a checkout process from the mobile electronic device 12.

At block 212, the checkout process is completed. In particular, the items acquired by the customer 11 and placed in the shopping cart 14 during shopping are purchased, in particular, payment is made for the items of interest acquired by the customer 11.

At block 214, the status indicator 16 emits a different color light than the “in use” color, for example, a green color emitting LED or the like that indicates that the checkout process is complete. The status indicator 16 can receive a command from the cart processor 18 in response to a signal received from the store computer 20. At block 216, a viewer such as a store associate can view the illuminated indicator 16. In embodiments where a different indicator is generated, such as a sound instead of a visual indicator, the store associate can hear the sound emitted by the status indicator 16.

At block 218, the shopper 11 is authorized to exit the store. The store associate may acknowledge by viewing the status indicator 16 indicating a state that the checkout process is complete, e.g., the status indicator 16 is green. If the status indicator 11 indicates a state that the checkout process is not complete, e.g., the status indicator is red, then the store associate may intervene, for example, informing the shopper 11 that the checkout process is not complete, or notifying security or other action.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A method of notification of a store checkout, comprising:
establishing a communication between a mobile application at a user mobile electronic device and a shopping cart;
activating a status indicator on the shopping cart to have a first state indicating that the shopping cart is in use;
completing a checkout process; and
changing the status indicator to have a second state indicating the completion of the checkout process.

2. The method of claim 1, wherein the status indicator is a light emitting device that emits light having a first color in the first state and emits light having a second color light in the second state.

3. The method of claim 1, wherein the checkout process includes payment of all of the items in the shopping cart.

4. The method of claim 1, wherein the communication is established by the shopping cart providing the user mobile electronic device with an identifier.

5. The method of claim 4, wherein the identifier of the shopping cart is used by a store server to activate the status indicator to be in the first state on the shopping cart.

6. The method of claim 5, wherein the checkout process is performed by the mobile application of the user mobile electronic device, which in response sends a signal to the store server to change the status indicator from the first state to the second state.

7. The method of claim 6, wherein the checkout process is performed by a combination of a point of sale system and the mobile application of the user mobile electronic device.

8. The method of claim 4, wherein the identifier includes a serial number of the shopping cart.

9. A system for notification of a store checkout, comprising:
a shopping cart, including:
a processor that establishes a communication between a mobile application at a user mobile electronic device; and
a status indicator that indicates at least one of a first state where the mobile application is in communication with the shopping cart or a second state where the store checkout is complete; and
a store server that receives a signal from the mobile application and at least one of activates the status indicator on the shopping cart when the signal includes an identifier of the shopping cart confirming communication between the mobile application and the shopping cart or changes the status indicator from the first state to the second state when the signal includes a checkout completion acknowledgement indicating the completion of the store checkout.

10. The system of claim 9, further comprising:
a point of sale (POS) device at a checkout region of the store that processes data related to the store checkout.

11. The system of claim 9, wherein the status indicator is a light emitting device that emits light having a first color in the first state and emits light having a second color light in the second state.

12. The system of claim 9, wherein the checkout process includes payment of all of the items in the shopping cart.

13. The system of claim 9, wherein the shopping cart processor outputs to the user mobile electronic device an identifier.

14. The system of claim 13, wherein the store server activate the status indicator to be in the first state on the shopping cart in response to receiving the identifier from the mobile electronic device.

15. The system of claim 14, wherein the store server changes the status indicator from the first state to the second state in response to the store server receiving the checkout completion acknowledgement from the mobile electronic device.

16. The system of claim 14, wherein the store server changes the status indicator from the first state to the second state in response to the store server receiving the checkout completion acknowledgement from a point of sale system.

17. The system of claim 14, wherein the identifier includes a serial number of the shopping cart.

18. A method for changing a status of an indicator on a store shopping cart, comprising:
activating a status indicator on the shopping cart to have a first state indicating that a shopping cart is in use when a communication is established between the shopping cart and a mobile electronic device of a shopping using the shopping cart; and
changing the status indicator to have a second state indicating the completion of the checkout process when the user has purchased items of interest.
